(19) United States
(12) Patent Application Publication
(10) Pub. No.: US 2004/0158474 A1
(43) Pub. Date: Aug. 12, 2004

(54) Service facility for providing remote diagnostic and maintenance services to a process plant

(76) Inventors: Robert J. Karschnia, Chaska, MN (US); Marcos Peluso, Chanhassen, MN (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/359,902

(22) Filed: Feb. 6, 2003

(51) Int. Cl. G06F 17/60

(52) U.S. Cl. 705/1

(57) ABSTRACT

A system for providing remote diagnostic and maintenance services to a process plant includes a database and a server, both of which are located remotely from the process plant. The database includes a plurality of applications. The server includes a data collection unit, an analysis unit, and a control unit. The data collection unit collects data associated with the process plant via a communication link, such as the Internet. The analysis unit analyzes the collected data to detect a condition associated with the process plant. In response to the detected condition, the control unit automatically implements one or more of the applications by automatically executing one or more of the applications remotely and determining parameters to be communicated to the process plant, automatically downloading one or more applications to the process plant via the Internet, and/or activating a web page that provides information for guiding an operator located at the plant in correcting the detected condition.

### TECHNICAL FIELD

The present invention relates generally to process plants and, more particularly, to a service facility that provides remote diagnostic and maintenance services to a process plant.

### DESCRIPTION OF THE RELATED ART

Process plants, like those used in chemical, petroleum, or other processes, typically include one or more centralized or decentralized process controllers communicatively coupled to at least one host or operator workstation and to one or more process control and instrumentation devices, such as field devices, via analog, digital or combined analog/digital buses. Field devices, which may be, for example valves, valve positioners, switches, transmitters, and sensors (e.g., temperature, pressure, and flow rate sensors), perform functions within the process such as opening or closing valves and measuring process parameters. The process controller receives signals indicative of process measurements or process variables made by or associated with the field devices and/or other information pertaining to the field devices via the communication buses, uses this information to implement a control routine, and then generates control signals which are sent over one or more of the buses to the field devices to control the operation of the process. Information from the field devices and the controller is typically made available to one or more applications executed by an operator workstation to enable an operator to perform desired functions with respect to the process, such as viewing the current state of the process, modifying the operation of the process, etc.

In the past, conventional field devices were used to send and receive analog (e.g., 4 to 20 milliamp) signals to and from the process controller via an analog bus or analog lines. These 4 to 20 mA signals were limited in nature in that they were indicative of measurements made by the device or of control signals generated by the controller required to control the operation of the device. However, in the past decade or so, smart field devices that perform one or more process control functions have become prevalent in the process control industry. In addition to performing a primary function within the process, each smart field device includes a memory and a microprocessor having the capability to store data pertaining to the device, communicate with the controller and/or other devices in a digital or combined digital and analog format, and perform secondary tasks such as self-calibration, identification, diagnostics, etc. A number of standard, open, digital or combined digital and analog communication protocols such as the HART®, PROFIBUS®, FOUNDATION™ Fieldbus, WORLDFIP®, Device-Net®, and CAN protocols have been developed to enable smart field devices made by different manufacturers to be interconnected within a process control network to communicate with one another, and to perform one or more process control functions.

The all-digital, two-wire bus protocol promulgated by the Fieldbus Foundation, known as the FOUNDATION™ Fieldbus (hereinafter “Fieldbus”) protocol uses function blocks located in different field devices to perform control operations typically performed within a centralized controller. In particular, each Fieldbus field device is capable of including and executing one or more function blocks, each of which receives inputs from and/or provides outputs to other function blocks (either within the same device or within different devices). Each function block may also perform some process control operation such as measuring or detecting a process parameter, controlling a device, or performing a control operation such as implementing a proportional-integral-derivative (PID) control routine. The different function blocks within a process plant are configured to communicate with each other (e.g., over a bus) to form one or more process control loops, the individual operations of which are spread throughout the process and are, thus, decentralized.

With the advent of smart field devices, it is more important than ever to be able to quickly diagnose and correct problems that occur within a process plant. The failure to detect and correct poorly performing loops and devices leads to sub-optimal performance of the process, which can be costly in terms of both the quality and quantity of the product being produced. Typically, applications, i.e., routines used to perform functions within a process plant using information provided by the system, may be installed in and executed by a host or operator workstation. These applications may be related to process functions such as setting and changing set points within the process, and/or may be related to business functions or maintenance functions. For example, an operator may initiate and execute business applications associated with ordering raw materials, replacement parts or devices for the plant, as well as business applications related to forecasting sales and production needs, etc.

In addition, many process plants, especially those that use smart field devices, include maintenance applications that help to monitor and maintain many of the devices within the plant. For example, the Asset Management Solutions (AMS) application sold by Emerson Process Management, Performance Technologies enables communication with and stores data pertaining to field devices to ascertain and track the operating state of the field devices. This activity is typically called condition monitoring. An example of such a system is disclosed in U.S. Pat. No. 5,960,214 entitled “Integrated Communication Network for use in a Field Device Management System.” In some instances, the AMS application allows an operator to initiate communications with a field device to, for example, change parameters within the device and to run applications on the device, such as device configuration, device calibration, status-checking applications, etc.

On the other hand, many smart devices currently include self-diagnostic and/or self-calibration routines that can be used to detect and correct problems within the device. For example, the FieldVue and ValveLink devices made by Fisher Controls International, Inc. have diagnostic capabilities that can be used to correct certain problems. To be effective, however, an operator must recognize that a problem exists with the device and subsequently initiate the self-diagnostic and/or self-calibration features of the device. There are also other process control applications, such as auto tuners, that can be used to correct poorly tuned loops within a process plant. Again, however, it is necessary for an operator to identify a poorly operating loop and subsequently initiate the use of such auto tuners to be effective.

Still further, each device or function block within a process plant may have the capability to detect errors that occur therein and send a signal, such as an alarm or an event to notify a process controller or an operator workstation that an error or some other problem has occurred. However, the occurrence of these alarms or events does not necessarily indicate a long-term problem with the device or loop that must be corrected. For instance, these alarms or events may be generated in response to other factors that were not a result of a poorly performing device or loop. Therefore, because a device or a function block within a loop generates an alarm or event does not necessarily mean that the device or loop has a problem that needs to be corrected. Furthermore, these alarms or events do not indicate the cause of the problem nor the solution to the problem. As a result, an operator is still required to make the determination of whether a device requires a repair, calibration, or some other corrective action in response to an alarm or event, and to subsequently initiate the appropriate corrective action.

Presently, it is known to provide a diagnostic tool that uses process control variables and information about the operating condition of the control routines or function blocks associated with process control routines to detect poorly operating devices or loops. In response to the detection of a poorly operating device or loop, the diagnostic tool may provide information to an operator about suggested courses of action to correct the problem. For example, the diagnostic tool may recommend the use of other, more specific diagnostic applications or tools to further pinpoint or correct the problem. An operator is then allowed to select which application or tool to execute to correct the problem. An example of such a system is disclosed in U.S. Pat. No. 6,298,454 entitled “Diagnostics in a Process Control System.” Similarly, there are other, more complex, diagnostic tools, such as expert systems, correlation analysis tools, spectrum analysis tools, neural networks, etc. that use information collected for a device or a loop to detect and help correct problems therein.

As noted above, to maintain efficient operation of the overall process, and thus minimize plant shutdowns and lost profits, devices associated with the process plant must function properly and reliably. Typically, one or more experienced human operators are primarily responsible for assuring that the devices within a process plant are operating efficiently and for repairing and replacing malfunctioning devices. Such operators may use tools and applications, such as the ones described above, that provide information about devices within the process. The maintenance applications may be installed in and executed by one or more operator workstations or controllers associated with the process plant to perform monitoring, diagnostic, and maintenance functions. Similarly, the maintenance applications may be executed by a separate computer or portable device located within the process plant and in communication with the devices. Unfortunately, however, these applications require significant expenditures for overhead such as, for example, specialized hardware and software, and highly skilled technicians and other specialists to support and oversee the daily monitoring activities. As a result, purchasing and supporting such applications within process plants often results in substantial costs to the plant owner. Likewise, due to the increasing number and complexity of monitoring, diagnostic, and maintenance applications available in the process control industry, it is often difficult, if not impossible, for an operator to become knowledgeable about all of the various applications in order to choose and implement the most suitable application to correct a poorly performing loop or device.

### SUMMARY

A system for providing remote diagnostic and maintenance services to a process plant includes a database and a server, both of which are located remotely from the process plant. The database includes a plurality of applications. The server includes a data collection unit, an analysis unit, and a control unit. The data collection unit collects data associated with the process plant via a communication link, such as the Internet. The analysis unit analyzes the collected data to detect a condition associated with the process plant. In response to the detected condition, the control unit automatically implements one or more of the applications by automatically executing one or more of the applications remotely and determining parameters to be communicated to the process plant, automatically downloading one or more applications to the process plant via the Internet, and/or activating a web page that provides information for guiding an operator located at the process plant in correcting the detected condition.

The remote system provides the advantage of maintaining the field devices and other equipment associated with the process plant in good operational order, and thus improving overall plant performance. Moreover, the system provides remote diagnostic and maintenance services to a process plant by diagnosing a problem associated with the plant, such as a poorly performing loop or device, and automatically implementing the appropriate software application or tool to correct the problem without the intervention of a human operator. These advantages eliminate the need for individual plants to purchase the software applications as well as the expensive overhead associated with supporting these applications. Still further, the remote system provides easy access to various software applications via a common medium such as the Internet, thus eliminating the need for expensive proprietary communication protocols and networks.

### BRIEF DESCRIPTION OF THE DRAWINGS

FIG. 1 is a schematic block diagram of a service facility in communication with a process plant to provide remote diagnostic and maintenance services to the process plant; and

FIG. 2 is a schematic block diagram of a service facility that uses Internet-based communications to provide remote diagnostic and maintenance services to a plurality of process plants.

### DETAILED DESCRIPTION

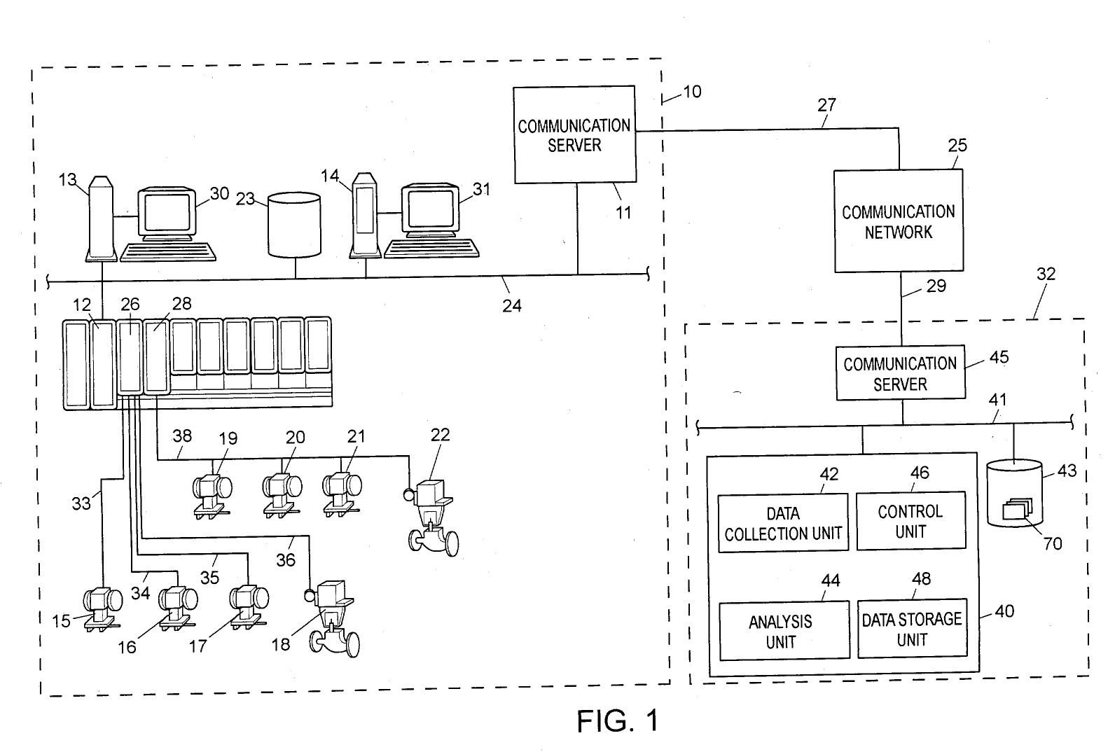

Referring now to FIG. 1, a process plant 10 includes a plurality of field devices 15-22 connected to a process controller 12 via one or more input/output devices 26 and 28. The process controller 12 may be a distributed control system (DCS) type controller such as, for example, a DeltaV™ controller sold by Fisher-Rosemount Systems, Inc., or any other type of controller for use in controlling field devices 15-22 that are connected to the process controller 12 in any conventional or any other desired manner. As shown in FIG. 1, the process controller 12 is communicatively coupled to one or more operator workstations 13 and 14 via a bus 24. The bus 24 may be, for example, an Ethernet-based bus and may use any desired or suitable local area network (LAN) or wide area network (WAN) protocol to provide communications. The operator workstations 13 and 14 may be based on a personal computer platform or any other suitable processing platform, and may perform a variety of known process control, maintenance, and other functions. In addition, the process plant 10 may include a data historian 23 that collects process control data via the bus 24. The data historian 23 is well known in the art and, thus, will not be described in further detail.

As is known, the process controller 12 may store and implement a control scheme to effect measurement and control of devices within the process to thereby control process parameters according to some overall control scheme. The process controller 12 may report status information to one or more applications stored within, for example, the operator workstations 13 and 14 regarding the operating state of the process and/or the operating state of the field devices 15-22. Of course, these applications may display any desired information to an operator or to a maintenance person within the process plant 10 via display devices 30 and 31 associated with operator workstations 13 and 14, respectively. It is to be understood that the process plant 10 illustrated in FIG. 1 is merely exemplary in nature and other types or configurations of process plants can be used as well.

The field devices 15-22 may be any types of devices, such as sensors, valves, transmitters, positioners, etc. while the I/O devices 26 and 28 may be any types of I/O devices conforming to any desired communication or controller protocol. As shown in FIG. 1, the process controller 12 is communicatively coupled to conventional (i.e., non-smart) field devices 15-18 via analog lines 33-36. Field devices 15-18 maybe standard 4-20 mA analog field devices that communicate over analog lines 33-36 to the I/O device 26. Similarly, field devices 19-22 may be smart devices, such as Fieldbus field devices, that communicate over a digital bus 38 to the I/O device 28 using Fieldbus non-proprietary protocol communications. Generally speaking, the Fieldbus protocol is an all-digital, serial, two-way communication protocol that provides a standardized physical interface to a two-wire loop or bus that interconnects field devices 19-22. The Fieldbus protocol provides, in effect, a local area network for field devices 19-22 within the process plant 10, which enables these field devices 19-22 to execute one or more process control loops either in conjunction with, or independently from the process controller 12. Of course, other types of devices and protocols such as the HART®, PROFIBUS®, WORLDFIP®, Device-Net®, AS-Interface and CAN protocols could be used as well.

The process controller 12 is configured to implement a control strategy using what are commonly referred to as function blocks. Each function block is a portion (e.g., a subroutine) of an overall control routine and operates in conjunction with other function blocks via communication links to implement process control loops within the process plant 10. Function blocks may perform either an input function, an output function, or a control function. The input function may be associated with a transmitter, a sensor, or other process parameter measurement device. The output function may control the operation of some device, such as a valve, to perform some physical function within the process plant 10. The control function may be associated with a control routine that performs PID, fuzzy logic, etc. control. Of course hybrid and other types of function blocks exist. Function blocks may be stored in and executed by the process controller 12, which is typically the case when these function blocks are associated with standard 4-20 mA devices and some types of smart field devices. In addition, function blocks may be stored in and implemented by the field devices themselves, which is the case with smart Fieldbus devices.

While the Fieldbus protocol uses the term “function block” to describe a particular type of entity capable of performing a process control function, it is noted that the term function block as used herein is not so limited and includes any sort of device, program, routine, or other entity capable of performing a process control function in any manner at distributed locations within a process control network. Thus, the remote service facility 32 described herein can be used with process plants 10 using other process control communication protocols or schemes (that may now exist or that may be developed in the future) which do not use what the Fieldbus protocol strictly identifies as a “function block.”

As illustrated in FIG. 1, the process plant 10 further includes a communication server 11, for example, a web server, communicatively coupled to any desired open communication network 25 such as, for example, the Internet via a communication link 27. The communication link 27 may be any suitable hardwired link such as a copper cable or other metal wire cable. Preferably, but not necessarily, the communication link 27 includes a fiber optic cable due to the increased bandwidth capacity associated with fiber optic networks. Still further, the communication link 27 may include any suitable wireless link such as, for example, a satellite or cellular phone link. Of course, the communication link 27 may be a hybrid of copper cable, fiber optic cable, and any wireless communication links.

The communication server 11, which may be implemented on a separate computer or workstation having software stored therein, enables the process plant 10 to communicate with the service facility 32 via the communication network 25. Alternatively or in addition, the communication server 11 functionality may be implemented within the process controller 12 and/or the operator workstations 13 and 14, if desired. As will be discussed in further detail below, the process plant 10 may send and receive measurement information, device information, control information, or any other device, loop, and/or process information to and from the remote service facility 32 via the communication network 25.

The service facility 32 includes a data collection unit 42, an analysis unit 44, a control unit 46, and a data storage unit 48, all of which may collectively form an application server 40. Each of the data collection unit 42, the analysis unit 44, the control unit 46, and the data storage unit 48, is preferably, but not necessarily implemented using one or more software routines that may be executed within the application server 40. In particular, the application server 40 may include one or more processors having associated memory that store and execute a number of routines to perform the steps of collecting data associated with the process plant 10, analyzing the collected data to detect a condition associated with the process plant 10, and automatically implementing an appropriate software application 70 in response to the detected condition. Of course, the processor may be a microprocessor, microcontroller, Application Specific Integrated Circuit (ASIC), or other processing device that is configured or programmed to perform the various data collection, control, and analysis activities described in further detail below.

As illustrated in FIG. 1, the application server 40 is in communication with a database 43 via a bus 41. The bus 41 may be an Ethernet-based LAN or WAN, or any other suitable bus. The database 43 stores a plurality of software tools or applications 70 that perform monitoring, diagnostic and/or maintenance activities for field devices 15-22, loops, and other equipment associated with the process plant 10. More specifically, the software applications 70 may include a device calibration application, a device configuration application, an auto tuner application, a process monitoring application, a control loop monitoring application, a device monitoring application, an equipment monitoring application, an index generation application, a work order generation application, or any other applications related to monitoring, diagnosing, and/or maintaining field devices 15-22 and other equipment within the process plant 10.

In particular, the data collection unit 42 may be configured to automatically collect data from the process plant 10 via the communication network 25 in real-time as the process is running. The data collection unit 42 may collect data from either the process controller 12, the operator workstations 13 and 14, the data historian 23, or directly from one or more of the smart field devices 19-22. Alternatively, the process plant 10 may periodically collect predetermined data associated with the plant 10 and send that data to the remote service facility 32 at a periodic or non-periodic rate via the communication network 25. For example, the process plant 10 may include an expert data collection tool or application stored in one of the operator workstations 13 and 14 for insuring that the proper data is sent to the remote service facility 32 in a timely or periodic manner.

The collected data may include data pertaining to the health, variability, performance, or utilization of a device, loop, function block, etc. associated with the process plant 10. In particular, the data collection unit 42 may collect data that may be used to determine the health of a field device including determining dead band, dead time, response time, overshoot, etc. of a device and/or alarms and events generated by the smart field devices 19-22.

Upon receiving the collected data, the analysis unit 44 may detect a condition associated with the process plant 10 and may determine which field devices 15-22 or control loops associated with the process plant 10 are operating sub-optimally or are improperly tuned based on the collected data. If desired, the analysis unit 44 may compare the collected data with one or more stored parameters to determine if the collected data are within an acceptable range. For example, the analysis unit 44 may compare a statistical measure (such as the mean, median, etc.) of the measurements made by a field device over a predetermined period of time and/or the actual or instantaneous value of the measurement to a specific operating range or limit to detect an out-of-range measurement. Similarly, by examining the appropriate bit of the block error parameter generated by one of the smart field devices 19-22 during an alarm or event, the analysis unit 44 may determine whether an alarm or event requires immediate corrective action because it is limiting the operation of the device, or whether the alarm or event is associated with a condition that is not critical to, or which would not adversely affect the results of the process, and therefore does not require immediate action. Of course, any other desired processing of the collected data could be performed using any known techniques or available applications.

The service facility 32 further includes a communication server 45, for example a web server, communicatively coupled to the communication network 25 via a communication link 29. As with communication link 27, the communication link 29 may be a hardwired link, a wireless link, or any desired combination of hardwired and/or wireless links. The communication server 45 associated with the service facility 32, which may be implemented on a separate computer having software stored therein, enables the service facility 32 to receive data and information from, and send information to the process plant 10 via the communication network 25. Alternatively or in addition, the communication server 45 functionality may be implemented within the application server 40.

During operation of the plant 10, the analysis unit 44 analyzes the collected data to detect one or more conditions associated with the process plant 10 in accordance with a set of stored rules or other algorithms. Upon detecting a condition, the analysis unit 44 produces a condition indication indicative of the detected condition. The condition indication may be one of a plurality of predefined conditions stored in the analysis unit 44. In response to the condition indication, the control unit 46 may automatically implement an appropriate software application 70 to further analyze the detected condition and/or to correct the detected condition. Generally speaking, the control unit 46 may automatically implement the appropriate software application 70 based on the type of condition (e.g., aberrant measurements, calculations, control loops, etc.), the nature or identity of the source of the condition (e.g., whether it originated in a control or input function block, a transmitter, a valve, etc.), or any other desired criteria.

The control unit 46 may automatically execute the appropriate software application 70 locally at the service facility 32 and calculate parameters to, for example, tune a control loop or calibrate, configure, monitor, and/or troubleshoot the field devices 15-22. Examples of parameters capable of being calculated by the control unit 46 include tuning parameters, indexes for the process plant 10, or any other parameters capable of being provided by the software applications 70. As an example, the control unit 46 may provide wizards to calculate strapping table parameter calculations, flow correction factors, etc. In this manner, a user could enter data and parameters could then be downloaded to the process plant 10. In any event, the service facility 32 may communicate the calculated parameters to the process plant 10 via the communication server 45 and the communication network 25. In particular, the service facility 32 may communicate the calculated parameters to individual smart field devices 19-22 using a device description written in a communication protocol associated with the smart field devices 19-22. Of course, the service facility 32 may also communicate the calculated parameters to the process controller 12 and/or the operator workstations 13 and 14.

Alternatively or in addition, the control unit 46 may automatically download the appropriate software application 70 to the process controller 12, operator workstations 13 and 14, and/or individual smart field devices 19-22 associated with the process plant 10. The software applications 70 may then be implemented under the direction of the control unit 46, in the appropriate sequence, and at the appropriate times to carry out the desired actions. Still further, the control unit 46 may activate a web page providing graphical and/or textual information such as, for example, instructions from an operator's manual, for guiding an operator at the process plant 10 in manually troubleshooting and/or correcting the detected condition.

The data storage unit 48 may be used to organize and provide long-term storage for one or more of the collected data, the condition indications, and calculated parameters. In this manner, operators and other plant personnel may access the information at any future date via the communication network 25.

It should be understood that the control unit 46 may automatically implement multiple software applications 70, either concurrently or successively, to correct the detected condition. As an example, the control unit 46 may automatically implement a device monitoring application based on a detected condition indicating that further analysis is required to pinpoint a condition associated with a field device. In turn, the control unit 46 may, based on the results of the device monitoring application, determine that a particular field device needs to be replaced, and may automatically execute a work order generation application to order a replacement part. If desired, the control unit 46 may automatically order the replacement part directly from a supplier 80 via the Internet 85. In this manner, the remote service facility 32 eliminates the need for an operator at the process plant 10 to perform these functions manually. Alternatively, an engineering device solution application may be accessed to help the operator choose the correct devices for the application. In turn, the control unit 46 may automatically place the order for the devices.

While FIG. 1 depicts the communication network 25 as a single network such as, for example, the Internet or other public communication network, that links the process plant 10 to the remote service facility 32, a plurality of other network structures or types may be used instead. For example, the process plant 10 may be communicatively coupled to the service facility 32 via a network that may be based on Ethernet or some other protocol or standard.

In addition, while the software routines making up the application server 40 have been described as being stored and executed in a distributed manner using a plurality of processing units (i.e., the data collection unit 42, the analysis unit 44, the control unit 46, and the data storage unit 48) that are communicatively coupled to each other, it should be understood that the software routines of the application server 40 may be stored and executed within a single processing unit. Furthermore, each of the data collection unit 42, the analysis unit 44, the control unit 46, and the data storage unit 48 need not be located within a single server computer at a single location. Rather, one or more of the units 42, 44, 46, and 48 may be located at different geographical locations from each other, and adapted to communicate with each other via, for example, the Internet. Still further, while FIG. 1 shows the plurality of software applications 70 being located in a database 43 that is separate and distinct from the application server 40, it should be recognized that the software applications 70 could, instead, be stored and executed within the application server 40 itself.

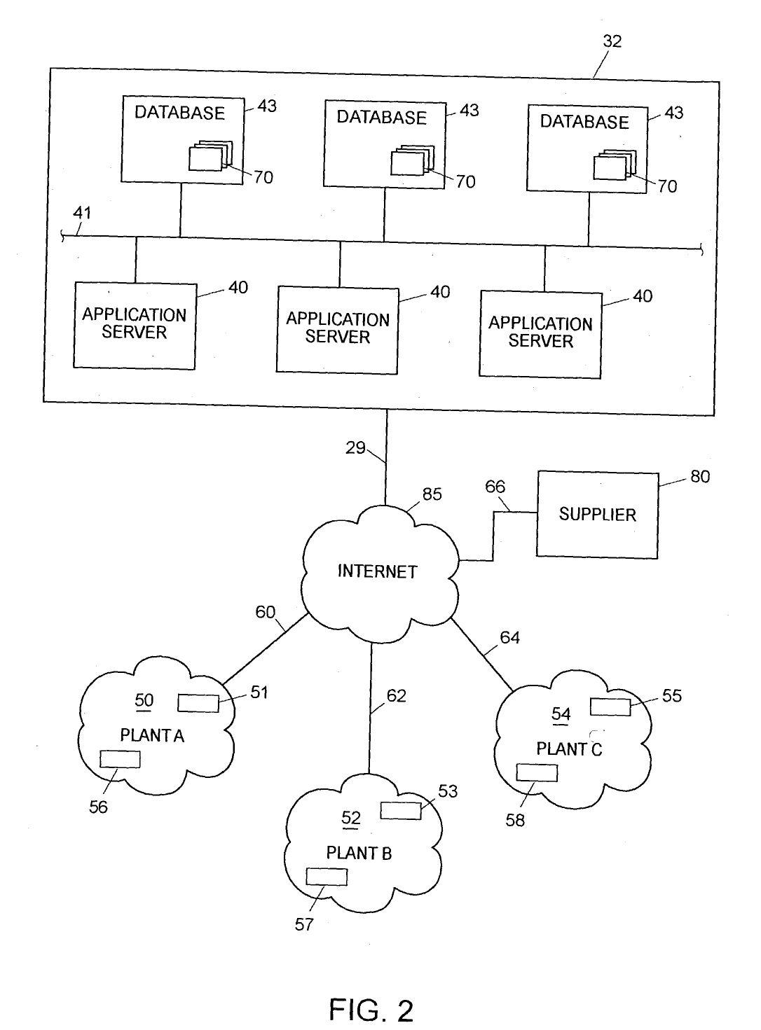

Referring now to FIG. 2, the remote service facility 32 enables one or more independently operable process plants 50, 52, and 54 that are physically remote from each other and from the service facility 32 to remotely access a plurality of software applications 70 via the Internet 85. As shown in FIG. 2, the service facility 32 may include a plurality of application servers 40 and a plurality of databases 43, all of which are communicatively coupled via a bus 41. Generally speaking, the plurality of application servers 40 may operate as a cluster or server farm, with processing and communications activities distributed across the multiple servers 40. As a result, computing capacity is greatly increased, thus reducing the risk of overwhelming a single server. However, in the event that one server fails, another server in the cluster may function as a backup.

Each of the databases 43 and application servers 40 may be located at a single location within the service facility 32 or, alternatively, may be located in different geographical locations from each other and/or the service facility 32, and adapted to communicate via any suitable communication network. As is also shown in FIG. 2, each of the process plants 50, 52, and 54 may include respective data historians 56-58 that collect process control, maintenance, and other data. As noted above, data historians are well known in the art and, thus, will not be described in further detail.

Each of the process plants 50, 52, and 54 may be owned by different business entities. Alternatively, multiple ones of the process plants 50, 52, and 54 may be grouped within a single business entity. In any event, each of the process plants 50, 52, and 54 is communicatively coupled to the Internet 85 via respective communication servers 51, 53, and 55 and respective secure communication links 60, 62, and 64. In this manner, individual process plants 50, 52, and 54 may independently communicate with the service facility 32 over a secure connection. For example, the service facility 32 may store and transmit data in a secure environment utilizing industry-standard Secure Sockets Layer (SSL) technology providing robust encryption and/or data may be accessed via password protected areas specific to individual customers.

The service facility 32 allows the process plants 50, 52, and 54 to have access to a multitude of software applications 70 without having to individually purchase the software applications 70 and associated hardware, software, and other support for the applications 70. Instead, the process plants 50, 52, and 54 may pay a subscription fee to use the services provided by the remote service facility 32. If desired, different levels of service may be sold by the service facility 32 to provide different types or numbers of monitoring, diagnostic, and maintenance capabilities to a particular plant. In this manner, different plants can subscribe to different levels of monitoring, diagnostic, and maintenance services based on their actual needs, size, etc.

Still further, component, material, or other service suppliers 80 may be communicatively coupled to the Internet 85 via a communication link 66. While FIG. 2 shows the service facility 32, the process plants 50, 52, and 54, and the supplier 80 as being communicatively coupled via the Internet 85, it is important to recognize that any other similar open communication network could be used as well.

Generally speaking, the service facility 32 provides outsourced or third-party device, loop, and/or process monitoring, diagnostic, and maintenance services on a subscription basis to a client or customer, such as, for example, one or more of the process plants 50, 52, and 54, via the Internet 85. Therefore, the individual plants 50, 52, and 54 do not have to acquire the software, hardware, support personnel, etc. associated with the various monitoring, diagnostic, and maintenance applications. In this manner, the relatively high costs associated with building and maintaining the infrastructure of the service facility 32 may be shared among the plurality of physically separate process plants 50, 52, and 54 and, if desired, among a plurality of business entities, each of which may be operating one or more process plants 50, 52, and 54 in physically remote locations. Thus, in contrast to prior systems, which required that each process plant 50, 52, and 54 purchase its own monitoring, diagnostic, and maintenance applications, as well as any updated or revised versions of the applications 70, a process plant may be able to cost effectively realize the benefits of having access to such applications.

In practice, the plants 50, 52, and 54 may have relatively short-term, nonexclusive software licensing agreements with the service facility 32. The service facility 32 may use the amount of processing time, the number of applications 70 implemented, the type of applications 70 implemented, or any other suitable metric to determine the fees to be charged to any particular customer.

Additionally, in contrast to conventional process diagnostic and control techniques and systems that typically require special (possibly custom) software and sometimes hardware to communicate with a plant that uses a proprietary communication protocol, the service facility 32 enables remote users or operators to troubleshoot, repair, access information and/or data stored in the data storage unit 48, etc. using conventional internet browser software that is already being executed on virtually any workstation, portable computer, etc.

It should be understood that the application server 40, and any component thereof, including the data collection unit 42, the analysis unit 44, the control unit 46, and the data storage unit 48, etc. may be implemented in hardware, software, firmware, or any combination thereof. In any event, the recitation of a routine stored in a memory and executed on a processor includes hardware and firmware devices as well as software devices. For example, the components described herein may be implemented in a standard multipurpose CPU, or on specifically designed hardware or firmware such as an ASIC or other hardwired devices, and still be a routine executed in a processor. When implemented in software, the software routine may be stored in any computer readable memory such as a magnetic disk, a laser disk, an optical disk, a RAM, ROM, EEPROM, a database, or any other storage medium known to those skilled in the art.

Thus, while the present invention has been described with reference to specific examples, which are intended to be illustrative only and not to be limiting of the invention, it will be apparent to those of ordinary skill in the art that changes, additions, or deletions may be made to the disclosed embodiments without departing from the spirit and scope of the invention.

What is claimed is:

1. A system for providing remote diagnostic and maintenance services to a process plant, the system comprising:
a database located remotely from the process plant, wherein the database includes a plurality of applications;
a data collection unit adapted to collect data associated with the process plant via a communication link;
an analysis unit adapted to analyze the collected data to detect a condition associated with the process plant; and
a control unit adapted to automatically implement at least one of the plurality of applications in response to the detected condition.

2. The system of claim 1, wherein the control unit is adapted to automatically execute at least one of the plurality of applications and determine parameters in response to the detected condition, and wherein the control unit is further adapted to communicate the determined parameters to the process plant via the communication link.

3. The system of claim 1, wherein the control unit is adapted to automatically download at least one of the plurality of applications to the process plant via the communication link.

4. The system of claim 1, wherein the control unit is adapted to activate a web page that provides information for correcting the detected condition.

5. The system of claim 1, wherein the plurality of applications includes at least one of a device calibration application, a device configuration application, an auto tuner application, a process monitoring application, a control loop monitoring application, a device monitoring application, an equipment monitoring application, an index generation application, and a work order generation application.

6. The system of claim 1, wherein the analysis unit is adapted to produce a condition indication indicating the condition associated with the process plant in response to the collected data.

7. The system of claim 6, further including a data storage unit adapted to store at least one of the condition indication and the collected data.

8. The system of claim 1, wherein the process plant includes a plurality of field devices, and wherein the collected data includes an alarm generated by one of the plurality of field devices.

9. The system of claim 1, wherein the communication link is an open network.

10. The system of claim 9, wherein the open network is the Internet.

11. The system of claim 1, wherein the communication link includes at least one of a hardwired communication link and a wireless communication link.

12. The system of claim 11, wherein the hardwired communication link includes at least one of a fiber optic cable and a metal wire cable.

13. The system of claim 11, wherein the wireless communication link includes at least one of a satellite communication link and a cellular communication link.

14. The system of claim 1, wherein the process plant is associated with a first business entity, and wherein each of the database, the data collection unit, the analysis unit, and the control unit is associated with a second business entity.

15. The system of claim 1, wherein each of the data collection unit, the analysis unit, and the control unit is located in a server.

16. The system of claim 15, wherein the database is located in the server.

17. The system of claim 15, wherein the server and the database are located in different geographical locations from each other and adapted to communicate with each other via a network.

18. A system for providing access to a plurality of applications, the system comprising:
a service facility associated with a first business entity;
a first process system associated with a second business entity and communicatively coupled to the service facility via an open network;
a second process system associated with a third business entity and communicatively coupled to the service facility via the open network;
wherein the service facility includes,
at least one database including the plurality of applications; and
a plurality of computer systems communicatively coupled to at least one database and to each other, wherein each of the plurality of computer systems is adapted to collect data associated with the first process system and the second process system and detect a condition associated with the first and second process systems in response to the collected data, and wherein each of the plurality of computer systems is further adapted to automatically implement at least one of the plurality of applications in response to the detected condition.

19. The system of claim 18, wherein each of the plurality of computer systems is adapted to automatically execute at least one of the plurality of applications and determine parameters in response to the detected condition, and wherein each of the plurality of computer systems is further adapted to communicate the determined parameters to each of the first and second process systems via the open network.

20. The system of claim 18, wherein each of the plurality of computer systems is adapted to automatically download at least one of the plurality of applications to each of the first and second process systems via the open network in response to the detected condition.

21. The system of claim 18, wherein each of the plurality of computer systems is adapted to activate a web page that provides information for correcting the detected condition.

22. The system of claim 18, wherein the service facility is adapted to store at least one of the collected data and the detected condition associated with the first and second process systems, and wherein each of the second business entity and the third business entity is adapted to access the collected data and the detected condition via a secure connection.

23. The system of claim 18, wherein the plurality of applications includes at least one of a device calibration application, a device configuration application, an auto tuner application, a process monitoring application, a control loop monitoring application, a device monitoring application, an equipment monitoring application, an index generation application, and a work order generation application.

24. The system of claim 18, wherein each of the plurality of computer systems is located at different geographical locations.

25. A method for providing a plurality of applications to a process plant, the method comprising the steps of:
collecting data associated with the process plant;
detecting a condition associated with the process plant in response to the collected data; and
automatically implementing at least one of the plurality of applications at a service facility located remotely from the process plant in response to the detected condition.

26. The method of claim 25, further including the step of billing the process plant based on at least one of a subscription fee, processing time, type of application implemented, and number of applications implemented.

27. The method of claim 25, wherein the step of automatically implementing at least one of the plurality of applications includes the steps of:
automatically executing at least one of the plurality of applications at the service facility;
determining parameters in response to the detected condition; and
communicating the determined parameters to the process plant.

28. The method of claim 27, further including the step of storing the determined parameters.

29. The method of claim 25, wherein the step of automatically implementing at least one of the plurality of applications includes the step of automatically downloading at least one of the plurality of applications to the process plant.

30. The method of claim 25, wherein the step of automatically implementing at least one of the plurality of applications includes the step of activating a web page that provides information for correcting the detected condition.

31. The method of claim 25, further including the step of determining a condition indication indicating the condition associated with the process plant in response to the collected data.

32. The method of claim 31, further including the step of storing at least one of the condition indication and the collected data.

33. A system for accessing a plurality of software applications from a service facility, the system comprising:
a processor located remotely from a process plant and communicatively coupled to the process plant via a communication link; and
a database located remotely from the process plant, wherein the database includes the plurality of applications;
wherein the processor is programmed to collect data from the process plant via the communication link, and wherein the processor is further programmed to detect a condition associated with the process plant in response to the collected data and automatically implement at least one of the plurality of applications in response to the detected condition.

34. The system of claim 33, wherein the process plant pays a subscription fee to access services provided by the service facility.

35. The system of claim 33, wherein the processor is programmed to automatically execute at least one of the plurality of applications and to determine parameters in response to the detected condition, and wherein the processor is further programmed to communicate the determined parameters to the process plant via the communication link.

36. The system of claim 33, wherein the processor is programmed to automatically download at least one of the plurality of applications to the process plant via the communication link.

37. The system of claim 33, wherein the processor is programmed to activate a web page that provides information for correcting the detected condition.

38. A control unit for providing a plurality of applications to a process plant, the control unit comprising:
a computer-readable medium located remotely from the process plant;
a first routine stored on the computer readable medium and adapted to be executed by a processor that collects data associated with the process plant via a communication network;
a second routine stored on the computer readable medium and adapted to be executed by the processor that analyzes the collected data to detect a condition associated with the process plant; and
a third routine stored on the computer readable medium and adapted to be executed by the processor that automatically implements at least one of the plurality of applications in response to the detected condition.

39. The control unit of claim 38, further including a fourth routine stored on the computer-readable medium and adapted to be executed by the processor that automatically executes at least one of the plurality of applications and determines parameters in response to the detected condition, and wherein the fourth routine is further adapted to communicate the determined parameters to the process plant via the communication network.

40. The control unit of claim 38, further including a fifth routine stored on the computer-readable medium and adapted to be executed by the processor that automatically downloads at least one of the plurality of applications to the process plant via the communication network.

41. The control unit of claim 38, further including a sixth routine stored on the computer-readable medium and adapted to be executed by the processor that activates a web page that provides information for correcting the detected condition.
